(19) United States
(12) Patent Application Publication
(10) Pub. No.: US 2025/0010922 A1
(43) Pub. Date: Jan. 9, 2025

(54) FENDER PANEL MOUNTING UNIT FOR VEHICLE BODY

(71) Applicants: Hyundai Motor Company, Seoul (KR); Kia Corporation, Seoul (KR)

(72) Inventor: Hyunsik Kim, Seoul (KR)

(21) Appl. No.: 18/469,783

(22) Filed: Sep. 19, 2023

(30) Foreign Application Priority Data
Jul. 3, 2023 (KR) 10-2023-0085495

(51) Int. Cl. B62D 25/16

(52) U.S. Cl. CPC B62D 25/163

(57) ABSTRACT

An embodiment fender panel mounting apparatus for mounting a fender panel on a fender apron member of a vehicle body is provided. The apparatus includes a lower mounting bracket connected to the fender apron member and having a strength reinforcement and an upper mounting bracket connected to an upper portion of the lower mounting bracket, connected to the fender panel, and having a strength variable portion.

### CROSS-REFERENCE TO RELATED APPLICATIONS

This application claims the benefit of Korean Patent Application No. 10-2023-0085495, filed on Jul. 3, 2023, which application is hereby incorporated herein by reference.

### TECHNICAL FIELD

The present invention relates to a front vehicle body structure of a vehicle.

### BACKGROUND

In general, a vehicle body is provided with fender apron members on both sides along the front width direction. A fender panel is mounted on each fender apron member. Fender panels are disposed on both left and right sides of a hood panel in the front of the vehicle body.

Such a fender panel may be coupled to a separate mounting bracket fixed to a fender apron member through a fastening member. The mounting bracket may absorb scattering of the assembly of the fender panel to the fender apron member while ensuring the strength of the joint of the fender panel.

On the other hand, the mounting bracket should be designed considering the pedestrian protection performance that may absorb and disperse the collision load of pedestrians through the fender panel.

However, if the strength of the mounting bracket is set weakly in consideration of the pedestrian protection performance to absorb the impact load of the pedestrian, an offset may occur between the fender panel and other parts due to deformation of the mounting bracket during assembly of the fender panel.

In order to prevent this, if the strength of the mounting bracket is set to be strong, contrary to the former, the risk of injury to the pedestrian may be increased in a collision with the pedestrian, so it is necessary to solve this difficult problem.

The above information disclosed in this background section is only for enhancement of understanding of the background of embodiments of the invention, and therefore it may contain information that does not form the prior art that is already known to a person of ordinary skill in the art.

### SUMMARY

The present invention relates to a front vehicle body structure of a vehicle. Particular embodiments relate to a fender panel mounting unit of a vehicle body that is configured to mount a fender panel on a front of the vehicle body.

Embodiments of the present disclosure provide a fender panel mounting unit of a vehicle body that secures the mounting strength of a fender panel for a fender apron member and secures pedestrian protection performance according to a collision with a pedestrian.

A fender panel mounting unit according to an exemplary embodiment for mounting a fender panel on a fender apron member of a vehicle body is provided. The fender panel mounting unit may include a lower mounting bracket connected to the fender apron member and having at least one strength reinforcement and an upper mounting bracket connected to an upper portion of the lower mounting bracket, connected to the fender panel, and having a strength variable portion.

The lower mounting bracket may include an upper surface, a lower front leg, and a lower rear leg, each extending downward from both ends of the upper surface along the front and rear direction of the vehicle body and connected to the fender apron member, and at least one side portion connected to the edge of the upper surface and the edges of the lower front leg and the lower rear leg.

The at least one side portion may include at least one strength reinforcement.

The lower front leg may include a front flange portion formed at a lower portion and connected to the fender apron member.

The lower rear leg may include a rear flange portion formed at a lower portion and connected to the fender apron member.

The upper mounting bracket may include a panel mounting portion engaged with the fender panel and an upper front leg and an upper rear leg extending downward from both ends of the panel mounting portion in the front and rear direction of the vehicle body and connected to the upper portion of the lower front leg and the lower rear leg, respectively.

The strength variable portion may be formed in multiple stages along the vertical direction in each of the upper front leg and the upper rear leg.

The strength variable portion may include a first deformation section bent in a lower direction through a first bending joint with a round shape at both ends of the panel mounting portion in the front and rear direction of the vehicle body and a second deformation section bent in a downward direction through a second bending joint with a round shape from the first deformation section.

At least one forming portion may be formed in each of the first bending joint and the second bending joint.

At least one strength adjusting hole may be formed in each of the first deformation section and the second deformation section.

The at least one strength adjusting hole may have a different size according to the predetermined strength of the upper mounting bracket.

The second deformation section may include a junction portion connected to the lower front leg and the lower rear leg of the lower mounting bracket by welding.

The panel mounting portion may include at least one connection hole formed to connect the fastening member.

The upper mounting bracket may be provided with a relatively smaller number of bracket plate bodies than the bracket plate bodies of the lower mounting bracket.

According to the exemplary embodiments of the present invention, when assembling the fender panel, it is possible to improve the appearance quality of the vehicle and secure the collision performance of the pedestrian by preventing the fender panel from being stepped due to the deformation of the bracket. In addition, it is possible to reduce the investment cost of part molding equipment.

In addition, the effects that can be obtained or predicted due to the embodiments of the present invention are disclosed directly or implicitly in the detailed description of the embodiments of the present invention. That is, various effects predicted according to an embodiment of the present invention will be disclosed within the detailed description to be described later.

### BRIEF DESCRIPTION OF THE DRAWINGS

Since these drawings are for reference in explaining exemplary embodiments of the present invention, the technical idea of the embodiments of the present invention should not be construed as limited to the accompanying drawings.

FIG. 1 is an exploded perspective view showing a fender panel mounting unit of a vehicle body according to an exemplary embodiment.

FIG. 2 is a perspective view of a fender panel mounting unit of a vehicle body according to an exemplary embodiment.

FIG. 3 is a cross-sectional view of a fender panel mounting unit of a vehicle body according to an exemplary embodiment.

FIG. 4 and FIG. 5 are perspective views showing a lower mounting bracket applied to a fender panel mounting unit of a vehicle body according to an exemplary embodiment.

FIG. 6 is a cross-sectional view showing a lower mounting bracket applied to a fender panel mounting unit of a vehicle body according to an exemplary embodiment.

FIG. 7 and FIG. 8 are perspective views showing an upper mounting bracket applied to a fender panel mounting unit of a vehicle body according to an exemplary embodiment.

FIG. 9 is a cross-sectional view showing an upper mounting bracket applied to a fender panel mounting unit of a vehicle body according to an exemplary embodiment.

The following reference identifiers may be used in connection with the drawings to describe various features of embodiments of the present invention.

| | |
|---|---|
| 1: fender apron member | 3: fender panel |
| 10: lower mounting bracket | 11: upper surface |
| 21: lower front leg | 23: front flange portion |
| 31: lower rear leg | 33: rear flange portion |
| 41: side portion | 45: strength reinforcement |
| 50: upper mounting bracket | 51: panel mounting portion |
| 53: connection hole | 61: upper front leg |
| 71: upper rear leg | 81: strength variable portion |
| 82: first deformation section | 83: second deformation section |
| 84: first bending joint | 85: second bending joint |
| 86: junction portion | 87, 97: forming portion |
| 88, 98: strength adjusting hole | 91: fastening member |
| 93: bolt | 95: nut |
| 100: fender panel mounting unit | |

The drawings referenced above are not necessarily drawn to scale but should be understood as presenting rather simplified representations of various preferred features illustrating the basic principles of embodiments of the present invention. For example, specific design features of embodiments of the present invention, including specific dimensions, directions, positions, and shapes, will be determined in part by specific intended applications and use environments.

### DETAILED DESCRIPTION OF ILLUSTRATIVE EMBODIMENTS

Hereinafter, with reference to the accompanying drawings, embodiments of the present invention will be described in detail so that those skilled in the art can easily carry out embodiments of the present invention. As those skilled in the art would realize, the described embodiments may be modified in various different ways, all without departing from the spirit or scope of the present invention.

The terminology used herein is for the purpose of describing specific exemplary embodiments only and is not intended to limit the present disclosure. As used herein, the singular forms are intended to include the plural forms as well, unless the context clearly indicates otherwise.

The terms ‘comprises’ and/or ‘comprising’ as used herein indicate the presence of specified features, integers, steps, operations, elements and/or components, but they do not exclude the presence or addition of one or more other features, integers, steps, operations, components, and/or groups thereof.

As used in this specification, the term ‘and/or’ includes any one or all combinations of at least one of the associated listed items.

In this specification, the term ‘connected’ indicates a physical relationship between two components, for example, in which components are directly connected to each other by welding, self piercing rivet (SPR), flow drill screw (FDS), structural adhesive, or the like, or in which components are indirectly connected through one or more intermediate components.

As used herein, ‘vehicle’, ‘vehicular’, ‘automotive’ or other similar terms as used herein generally refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based PBVs (purpose built vehicles), hydrogen-powered vehicles, and other alternative fuel vehicles (e.g., other than petroleum fuel derived from resources).

Hereinafter, embodiments of the present invention will be described in detail with reference to the accompanying drawings.

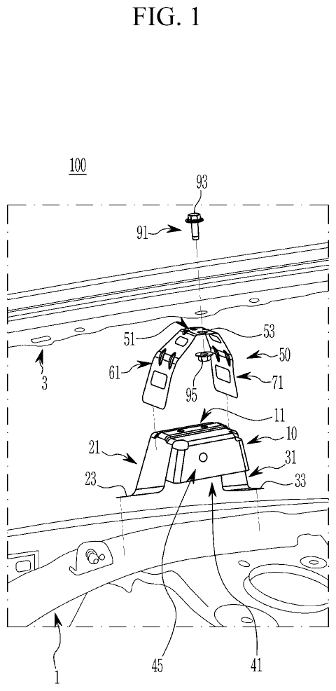

FIG. 1 is an exploded perspective view showing a fender panel mounting unit of a vehicle body according to an exemplary embodiment.

Referring to FIG. 1, a fender panel mounting unit 100 of a vehicle body according to an exemplary embodiment may be applied to a front structure body (e.g., a front vehicle body) of a vehicle body.

Here, the front structure body of the vehicle body includes front side members (not shown) provided on both sides along the left and right directions and a fender apron member 1 mounted on the front side member.

In the vehicle body panel mount process, a hood panel (not shown) and a fender panel 3 may be mounted on the front structure of the vehicle body. Among these, the fender panel 3 may be mounted on the fender apron member 1 by the fender panel mounting unit 100 of the vehicle body according to an exemplary embodiment.

In this specification, the ‘front to rear direction of the vehicle body’ may be defined as the longitudinal direction of the vehicle body, the ‘vehicle width direction’ may be defined as the left-right direction of the vehicle body, and the ‘up-and-down direction’ may be defined as the height direction of the vehicle body.

Furthermore, in this specification, ‘upper end’, ‘upper portion’, or ‘upper surface’ of a component indicates an end, portion, or surface of a component that is relatively upper in the drawing, and ‘lower end’, ‘ lower portion’, or ‘ lower surface’ of a component indicates an end, portion, or surface of a component that is relatively lower in the drawing.

Furthermore, in this specification, an end of a component (e.g., one end or another (other) end, etc.) denotes an end of a component in any one direction, and an end portion of the component (e.g., one end portion) or other (another) end portion, etc.) denotes a portion of a component that includes that end.

The fender panel mounting unit 100 of the vehicle body according to an exemplary embodiment may secure mounting rigidity of the fender panel 3 with respect to the fender apron member 1 and secure pedestrian protection performance due to collision with a pedestrian.

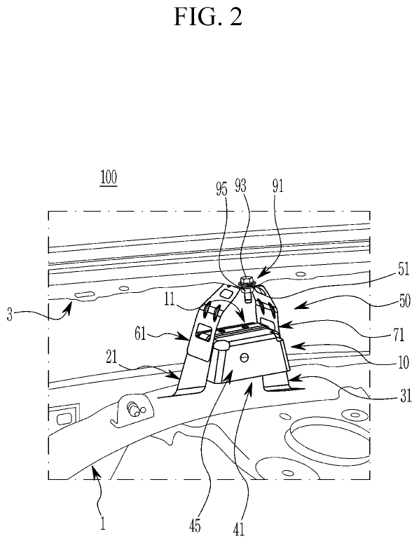

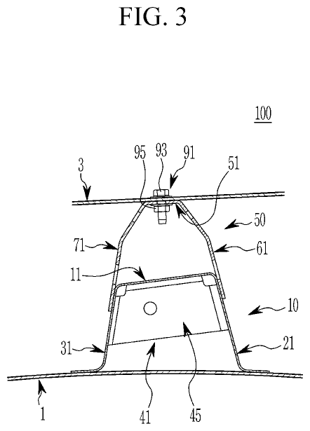

FIG. 2 is a perspective view of a fender panel mounting unit of a vehicle body according to an exemplary embodiment, and FIG. 3 is a cross-sectional view of a fender panel mounting unit of a vehicle body according to an exemplary embodiment.

Referring to FIG. 1 to FIG. 3, the fender panel mounting unit 100 of the vehicle body according to an exemplary embodiment includes a lower mounting bracket 10 and an upper mounting bracket 50.

In an exemplary embodiment, the lower mounting bracket 10 is configured to secure the mounting strength of the fender panel 3 to the fender apron member 1. When assembling the fender panel 3 to the fender apron member 1, the lower mounting bracket 10 has the strength to suppress deformation with respect to assembly torque.

The lower mounting bracket 10 is connected to the fender apron member 1. In one example, the lower mounting bracket 10 may be formed in a predetermined shape by press molding.

The lower mounting bracket 10 may be welded to an upper portion (e.g., a fender apron upper member) of the fender apron member 1. The lower mounting bracket 10 may include a plurality of bracket plate bodies.

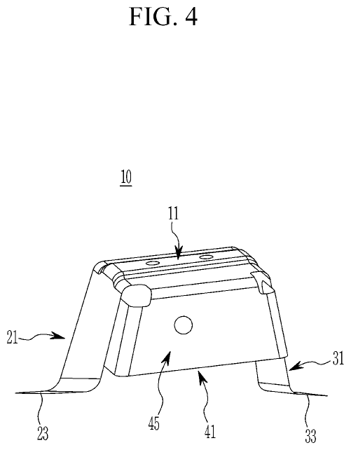

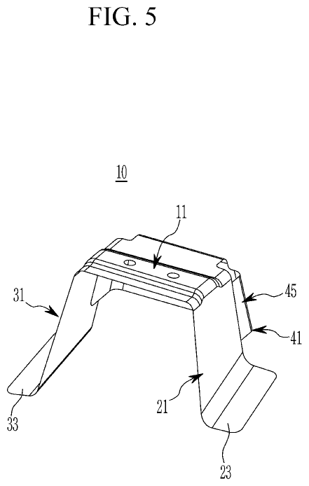

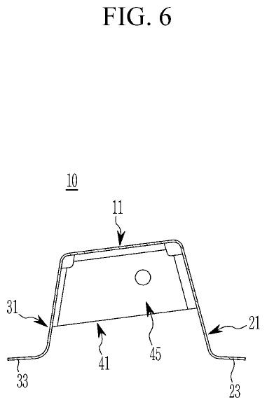

FIG. 4 and FIG. 5 are perspective views showing a lower mounting bracket applied to a fender panel mounting unit of a vehicle body according to an exemplary embodiment, and FIG. 6 is a cross-sectional view showing a lower mounting bracket applied to a fender panel mounting unit of a vehicle body according to an exemplary embodiment.

Referring to FIG. 1 to FIG. 6, the lower mounting bracket 10 according to an exemplary embodiment includes an upper surface 11, a lower front leg 21, a lower rear leg 31, and at least one side portion 41.

The upper surface 11 may be provided as an upper plate body formed on an upper portion of the lower mounting bracket 10.

Each of the lower front leg 21 and the lower rear leg 31 may be provided as a front plate body and a rear plate body along the front and rear direction of the vehicle body of the lower mounting bracket 10.

The lower front leg 21 and the lower rear leg 31 may be provided as plate bodies extending downward from both ends in the front and rear direction of the vehicle body of the upper surface 11, respectively. The lower front leg 21 and the lower rear leg 31 may be connected to the fender apron member 1.

The lower front leg 21 includes a front flange portion 23 formed at the lower end. The front flange portion 23 may be connected to the fender apron member 1 by welding.

The lower rear leg 31 includes a rear flange portion 33 formed at the lower end. The rear flange portion 33 may be welded to the fender apron member 1.

The at least one side portion 41 is configured to reinforce the strength of the lower mounting bracket 10. The at least one side portion 41 may be provided as a side plate body along the vehicle width direction.

The at least one side portion 41 is connected to the edge of the upper surface 11 and the edges of the lower front leg 21 and the lower rear leg 31 along the vehicle width direction. The at least one side portion 41 is disposed spaced apart from the upper portion of the fender apron member 1.

As in the drawing, the side portion 41 may be connected to one edge of the upper surface 11 along the vehicle width direction and edges of the lower front leg 21 and the lower rear leg 31 along the vehicle width direction.

However, the at least one side portion 41 is not limited thereto and may be connected to the other edge along the vehicle width direction of the upper surface 11 and the other edges along the vehicle width direction of the lower front leg 21 and the lower rear leg 31.

In addition, the at least one side portion 41 may be connected to both edges of the upper surface 11 along the vehicle width direction and both edges of the lower front leg 21 and the lower rear leg 31 along the vehicle width direction.

The at least one side portion 41 may include at least one strength reinforcement 45 in an exemplary embodiment.

The at least one strength reinforcement 45 is configured to reinforce the connection strength of the upper surface 11, the lower front leg 21, and the lower rear leg 31. That is, the at least one strength reinforcement 45 is configured to reinforce the strength of the lower mounting bracket 10 that mounts the fender panel 3 to the fender apron member 1.

Referring to FIG. 1 to FIG. 3, in an exemplary embodiment, the upper mounting bracket 50 is configured to secure pedestrian protection performance by absorbing and dispersing the impact load applied to the fender panel 3 when a vehicle collides with a pedestrian. That is, the upper mounting bracket 50 may be easily (or actively) deformed by the impact load of the pedestrian upon collision with the pedestrian.

Furthermore, the upper mounting bracket 50 is configured to increase the resistance of the assemble torque according to mounting the fender panel 3 to the fender apron member 1.

The upper mounting bracket 50 is connected to the upper portion of the lower mounting bracket 10 and is connected (e.g., engages) with the fender panel 3. In one example, the upper mounting bracket 50 may be formed into a predetermined shape by press molding.

The upper mounting bracket 50 may be welded to the upper portion of the lower mounting bracket 10. The upper mounting bracket 50 may include a plurality of bracket plate bodies.

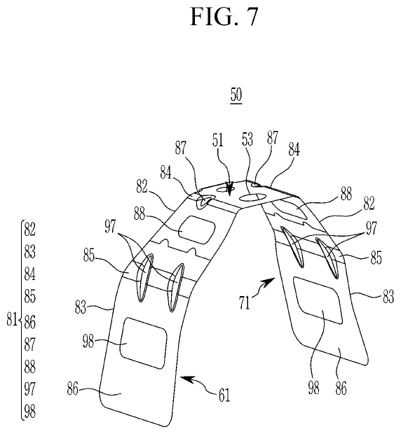

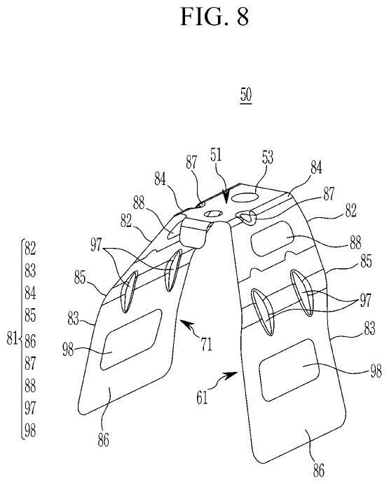

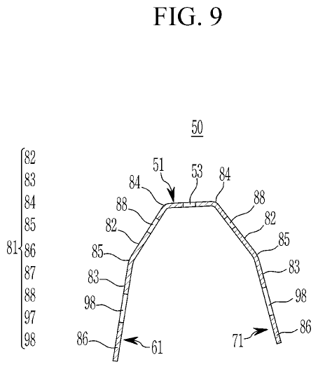

FIG. 7 and FIG. 8 are perspective views showing an upper mounting bracket applied to a fender panel mounting unit of a vehicle body according to an exemplary embodiment, and FIG. 9 is a cross-sectional view showing an upper mounting bracket applied to a fender panel mounting unit of a vehicle body according to an exemplary embodiment.

Referring to FIG. 1 to FIG. 9, the upper mounting bracket 50 according to an exemplary embodiment includes a panel mounting portion 51, an upper front leg 61, an upper rear leg 71, and a strength variable portion 81.

The panel mounting portion 51 is configured to mount (e.g., engage) the fender panel 3. In addition, the panel mounting portion 51 may receive a collision load of the pedestrian through the fender panel 3 when the pedestrian collides.

The panel mounting portion 51 may be provided as an upper plate body formed on the upper mounting bracket 50. The panel mounting portion 51 is disposed at a position corresponding to the upper surface 11 of the lower mounting bracket 10.

The panel mounting portion 51, as shown in in FIG. 1 to FIG. 3, may be engaged with the fender panel 3 through a fastening member 91. The fastening member 91 may be composed of, for example, a combination of a bolt 93 and a nut 95.

The panel mounting portion 51 includes at least one connection hole 53 formed to attach the nut 95 thereto. The nut 95 may be connected to a lower surface of the panel mounting portion 51 by welding (e.g., projection welding). The nut 95 is connected to at least one connection hole 53. And the bolt 93 may be engaged with the nut 95 through the fender panel 3 and at least one connection hole 53.

Each of the upper front leg 61 and the upper rear leg 71 may be provided as a front plate body and a rear plate body along the front and rear direction of the vehicle body of the upper mounting bracket 50.

The upper front leg 61 and the upper rear leg 71 may be provided as a plate body extending downward from both ends along the front and rear direction of the vehicle body of the panel mounting portion 51. The upper front leg 61 and the upper rear leg 71 are disposed in positions corresponding to the lower front leg 21 and lower rear leg 31 of the lower mounting bracket 10.

The upper front leg 61 and the upper rear leg 71 may be connected to the upper portion of the lower front leg 21 and the lower rear leg 31 by welding, respectively.

The upper mounting bracket 50 may be provided with a relatively smaller number of bracket plate bodies than the bracket plate bodies of the lower mounting bracket 10.

For example, the lower mounting bracket 10 may be provided with four bracket plate bodies having the upper surface 11, the lower front leg 21, the lower rear leg 31, and at least one side portion 41. The upper mounting bracket 50 may be provided with three bracket plate bodies having the panel mounting portion 51, the upper front leg 61, and the upper rear leg 71.

Since the four bracket plate bodies are the upper surface 11, the lower front leg 21, the lower rear leg 31, and at least one side portion 41 of the lower mounting bracket 10, separate drawing reference numbers for the four bracket plate bodies will be omitted.

In addition, since the three bracket plate bodies are the panel mounting portion 51, the upper front leg 61, and the upper rear leg 71 of the upper mounting bracket 50, separate drawing reference numbers for the three bracket plate bodies will be omitted.

The above strength variable portion 81 may increase the resistance of the assemble torque caused by mounting the fender panel 3 on the fender apron member 1 and may be configured to easily absorb and disperse the pedestrian impact load applied through the fender panel 3. In addition, the strength variable portion 81 is capable of adjusting the strength of the upper mounting bracket 50.

The strength variable portion 81 may be formed in multiple stages along the vertical direction of each of the upper front leg 61 and the upper rear leg 71, in one example, in at least two stages.

The strength variable portion 81, as shown in FIG. 7 to FIG. 9, includes a first deformation section 82 and a second deformation section 83.

The first deformation section 82 may be provided as a section that is bent in a lower direction from both ends of the panel mounting portion 51 in the front and rear direction of the vehicle body.

The first deformation section 82 may be bent in a downward direction from both ends of the panel mounting portion 51 through a first bending joint 84 having a round shape. The first bending joint 84 may be formed as a round section integrally connecting the panel mounting portion 51 and the first deformation section 82.

The second deformation section 83 may include sections each bent in a lower direction from the first deformation section 82.

The second deformation section 83 may be bent in a downward direction in the first deformation section 82 through a second bending joint 85 with a round shape. The second bending joint 85 may be formed as a round section integrally connecting the first deformation section 82 and the second deformation section 83.

The second deformation section 83 includes a junction portion 86 connected to the lower front leg 21 and the lower rear leg 31 of the lower mounting bracket 10. The junction portion 86 may be welded to the lower front leg 21 and the lower rear leg 31 of the lower mounting bracket 10.

Furthermore, each of the first bending joint 84 and the second bending joint 85 having a round shape includes at least one forming portion 87 and 97 concavely formed, respectively.

The at least one forming portion 87 and 97 is configured to reinforce the strength of each of the first bending joint 84 and the second bending joint 85. The at least one forming portion 87 and 97 may be formed as a shape concavely entered in a vertical direction and a front-back direction.

Furthermore, at least one strength adjusting hole 88 and 98 is formed in each of the first deformation section 82 and the second deformation section 83. The at least one strength adjusting hole 88 and 98 is configured to adjust the strength of the upper mounting bracket 50.

This at least one strength adjusting hole 88 and 98 may be formed in different sizes according to the predetermined strength of the upper mounting bracket 50. That is, the strength of the upper mounting bracket 50 may be adjusted according to the size of at least one strength adjusting hole 88 and 98.

Hereinafter, the assembly process and operation of the fender panel mounting unit 100 of the vehicle body according to an exemplary embodiment will be explained in detail with reference to FIG. 1 to FIG. 9.

In an exemplary embodiment, the fender panel 3 molded to a predetermined shape is provided. And, in an exemplary embodiment, the lower mounting bracket 10 and the upper mounting bracket 50 molded into a predetermined shape are provided, respectively.

The lower mounting bracket 10 includes the upper surface 11, the lower front leg 21, the lower rear leg 31, and at least one side portion 41 connected to each other. The upper mounting bracket 50 includes the panel mounting portion 51, the upper front leg 61, and the upper rear leg 71 connected to each other.

At least one side portion 41 of the lower mounting bracket 10 may be provided with at least one strength reinforcement 45.

In addition, the upper mounting bracket 50 includes the strength variable portion 81 formed on each of the upper front leg 61 and the upper rear leg 71. The strength variable portion 81 includes the first deformation section 82 and the second deformation section 83 formed in multiple stages (e.g., at least two stages) along the vertical direction in each of the upper front leg 61 and the upper rear leg 71.

With the fender panel 3, the lower mounting bracket 10, and the upper mounting bracket 50 provided, the lower mounting bracket 10 is connected to the fender apron member 1.

The lower mounting bracket 10 is welded to the fender apron member 1 via the lower front leg 21 and the lower rear leg 31. The lower front leg 21 and the lower rear leg 31 are connected to the fender apron member 1 through the front flange portion 23 and the rear flange portion 33 by welding, respectively.

The upper mounting bracket 50 is connected to the lower mounting bracket 10.

The upper mounting bracket 50 is welded to the upper portion of the lower mounting bracket 10 through the upper front leg 61 and the upper rear leg 71.

The upper front leg 61 and the upper rear leg 71 are welded to the upper portions of the lower front leg 21 and the lower rear leg 31 through the junction portion 86 formed in the second deformation section 83.

The fender panel 3 is engaged to the panel mounting portion 51 of the upper mounting bracket 50 through the fastening member 91 including the combination of the bolt 93 and the nut 95. At least one connection hole 53 is formed in the panel mounting portion 51. The nut 95 connected to at least one connection hole 53 is connected to the lower surface of the panel mounting portion 51.

When the bolt 93 penetrates the fender panel 3 and at least one connection hole 53 and engages the nut 95, the fender panel 3 may be coupled to the panel mounting portion 51 of the upper mounting bracket 50.

According to the fender panel mounting unit 100 of the vehicle body according to an exemplary embodiment assembled through the process described above, when assembling the fender panel 3 to the upper mounting bracket 50, the lower mounting bracket 10 may secure the mounting strength of the fender panel 3 by means of at least one strength reinforcement 45.

That is, since the lower mounting bracket 10 further includes at least one side portion 41 in addition to the upper surface 11, the lower front leg 21, and the lower rear leg 31, deformation due to assemble torque may be suppressed.

In addition, according to the fender panel mounting unit 100 of the vehicle body according to an exemplary embodiment, when assembling the fender panel 3 to the upper mounting bracket 50, the upper mounting bracket 50 may increase the resistance of the assemble torque by the strength variable portion 81.

To explain further, the first deformation section 82 of the strength variable portion 81 is connected to the panel mounting portion 51 through the first bending joint 84 having the round shape. And the second deformation section 83 of the strength variable portion 81 is connected to the first deformation section 82 through the second bending joint 85 of the round shape. In addition, at least one forming portion 87 and 97 is formed in each of the first bending joint 84 and the second bending joint 85.

Therefore, the upper mounting bracket 50 may increase resistance of assemble torque by the first deformation section 82 and the second deformation section 83 formed in multiple stages (e.g., at least two stages) along the vertical direction.

In addition, the upper mounting bracket 50 may minimize strength variation in the vertical direction due to the round shape of the first bending joint 84 and the second bending joint 85 through at least one forming portion 87 and 97.

As a result, when the fender panel mounting unit 100 of the vehicle body according to an exemplary embodiment assembles the fender panel 3, deformation of the upper mounting bracket 50 due to the assemble torque may be minimized, and the occurrence of an offset or differences between the fender panel 3 and other parts may be prevented.

Furthermore, the upper mounting bracket 50 may be easily deformed by the strength variable portion 81 when a collision load is applied through the fender panel 3 when a vehicle collides with a pedestrian.

Therefore, the fender panel mounting unit 100 of the vehicle body according to an exemplary embodiment absorbs and disperses the pedestrian's collision load applied to the fender panel 3 in the event of a pedestrian collision, thereby securing pedestrian protection performance.

Furthermore, as the upper mounting bracket 50 secures the strength of the first bending joint 84 and the second bending joint 85 by the at least one forming portion 87 and 97, the strength influence of the at least one strength adjusting hole 88 and 98 may be increased.

Accordingly, it is easy to adjust the strength of the upper mounting bracket 50 according to the size adjustment of the at least one strength adjusting hole 88 and 98. That is, the mounting strength of the fender panel 3 of the upper mounting bracket 50 and the strength for protecting a pedestrian in a collision may be adjusted by changing only the size of at least one strength adjusting hole 88 and 98.

As a result, the fender panel mounting unit 100 of the vehicle body according to an exemplary embodiment may reduce the investment cost of mold equipment for molding the upper mounting bracket 50 for each predetermined strength.

While embodiments of this invention have been described in connection with what is presently considered to be practical exemplary embodiments, it is to be understood that the embodiments of the invention are not limited to the disclosed embodiments. On the contrary, they are intended to cover various modifications and equivalent arrangements included within the spirit and scope of the appended claims.

What is claimed is:

1. A fender panel mounting apparatus for mounting a fender panel on a fender apron member of a vehicle body, the apparatus comprising:
a lower mounting bracket connected to the fender apron member and comprising a strength reinforcement; and
an upper mounting bracket connected to an upper portion of the lower mounting bracket, connected to the fender panel, and comprising a strength variable portion.

2. The apparatus of claim 1, wherein the lower mounting bracket comprises:
an upper surface;
a lower front leg and a lower rear leg each extending downward from both ends of the upper surface along a front and rear direction of the vehicle body and connected to the fender apron member; and
a side portion connected to an edge of the upper surface and edges of the lower front leg and the lower rear leg.

3. The apparatus of claim 2, wherein the side portion comprises the strength reinforcement.

4. The apparatus of claim 2, wherein:
the lower front leg comprises a front flange portion at a lower portion and connected to the fender apron member; and
the lower rear leg comprises a rear flange portion at a lower portion and connected to the fender apron member.

5. The apparatus of claim 2, wherein the upper mounting bracket comprises:
a panel mounting portion engaged with the fender panel; and
an upper front leg and an upper rear leg extending downward from both ends of the panel mounting portion in the front and rear direction of the vehicle body and connected to an upper portion of the lower front leg and an upper portion of the lower rear leg, respectively.

6. The apparatus of claim 5, wherein the strength variable portion is disposed in multiple stages along a vertical direction in each of the upper front leg and the upper rear leg.

7. The apparatus of claim 5, wherein the strength variable portion comprises:
a first deformation section bent in a lower direction through a first bending joint with a first round shape at both ends of the panel mounting portion in the front and rear direction of the vehicle body; and
a second deformation section bent in a downward direction through a second bending joint with a second round shape from the first deformation section.

8. The apparatus of claim 7, further comprising a forming portion provided in each of the first bending joint and the second bending joint, respectively.

9. The apparatus of claim 7, further comprising a strength adjusting hole provided in each of the first deformation section and the second deformation section, respectively.

10. The apparatus of claim 9, wherein the strength adjusting hole has a variable size according to a predetermined strength of the upper mounting bracket.

11. The apparatus of claim 7, wherein the second deformation section comprises a junction portion connected to the lower front leg and the lower rear leg of the lower mounting bracket by welds.

12. The apparatus of claim 5, wherein the panel mounting portion comprises a connection hole configured to connect a fastening member.

13. A fender panel mounting apparatus for mounting a fender panel on a fender apron member of a vehicle body, the apparatus comprising:
a lower mounting bracket connected to the fender apron member and comprising a strength reinforcement and a first plurality of bracket plate bodies; and
an upper mounting bracket connected to an upper portion of the lower mounting bracket, connected to the fender panel, and comprising a strength variable portion and a second plurality of bracket plate bodies, wherein the second plurality of bracket plate bodies comprises a smaller number of the bracket plate bodies than the first plurality of bracket plate bodies.

14. The apparatus of claim 13, wherein the lower mounting bracket comprises:
an upper surface;
a lower front leg and a lower rear leg each extending downward from both ends of the upper surface along a front and rear direction of the vehicle body and connected to the fender apron member; and
a side portion connected to an edge of the upper surface and edges of the lower front leg and the lower rear leg.

15. The apparatus of claim 14, wherein:
the lower front leg comprises a front flange portion at a lower portion and connected to the fender apron member; and
the lower rear leg comprises a rear flange portion at a lower portion and connected to the fender apron member.

16. The apparatus of claim 14, wherein the upper mounting bracket comprises:
a panel mounting portion engaged with the fender panel; and
an upper front leg and an upper rear leg extending downward from both ends of the panel mounting portion in the front and rear direction of the vehicle body and connected to an upper portion of the lower front leg and an upper portion of the lower rear leg, respectively.

17. The apparatus of claim 16, wherein the strength variable portion comprises:
a first deformation section bent in a lower direction through a first bending joint with a first round shape at both ends of the panel mounting portion in the front and rear direction of the vehicle body; and
a second deformation section bent in a downward direction through a second bending joint with a second round shape from the first deformation section.

18. The apparatus of claim 17, further comprising a forming portion provided in each of the first bending joint and the second bending joint, respectively.

19. The apparatus of claim 17, further comprising a strength adjusting hole provided in each of the first deformation section and the second deformation section, respectively.

20. The apparatus of claim 17, wherein the second deformation section comprises a junction portion connected to the lower front leg and the lower rear leg of the lower mounting bracket by welds.
